(19) United States
(12) Patent Application Publication
(10) Pub. No.: US 2002/0173421 A1
(43) Pub. Date: Nov. 21, 2002

(54) Preparation and use of palladium catalysts for cross-coupling reactions

(76) Inventors: Lars Rodefeld, Leverkusen (DE); Thomas Hopfner, Neuss (DE); Claus-Peter Reisinger, Ann Arbor, MI (US)

Correspondence Address: BAYER CORPORATION, PATENT DEPARTMENT, 100 BAYER ROAD, PITTSBURGH, PA, 15205, US

(21) Appl. No.: 10/144,080

(22) Filed: May 13, 2002

(30) Foreign Application Priority Data
May 16, 2001 (DE) 10123884.3

(51) Int. Cl. B01J 31/00

(52) U.S. Cl. 502/150; 502/152; 502/155

(57) ABSTRACT

The invention relates to a process for preparing meterable solutions or dispersions of palladium catalysts, to these solutions or dispersions of such catalysts, and to the use of such catalysts in cross-coupling reactions.

### BACKGROUND OF THE INVENTION

The invention relates to a process for preparing substituted aromatic compounds by palladium-catalyzed cross-coupling reactions using novel, meterable palladium(II) catalysts, which, like a process for preparing them, are likewise subject-matter of the invention.

Both Pd(0) and Pd(II) compounds, often stabilized by phosphine ligands, are used as catalysts for cross-coupling reactions of aromatics. Industrially important cross-coupling reactions are, for example, carbonylations, Heck reactions, Suzuki couplings, and alkyne couplings.

A wide variety of ligands, palladium compounds, and additives has been described in the literature for these applications, with the aim of achieving the highest possible yields and reaction rates. A review is given, for example, in R. F. Heck, “Palladium Reagents in Synthesis”, Academic Press, London 1985.

In the catalysis cycle of palladium-catalyzed cross-couplings, an important step is the oxidative addition of a ligand-stabilized Pd(0) species onto a halogenoaromatic or arylsulfonate (cf. L. S. Hegedus in “Organo-metallic Synthesis” Editor M. Schlosser, 1994, Wiley & Sons. Chichester).

Since Pd(0) species can participate directly in the catalysis cycle without a preceding reaction step, their use is advantageous on a laboratory scale. However, simple, commercially available Pd(0) compounds such as Pd(PPh₃)₄ have the disadvantage that they are extremely oxidation-sensitive and are difficult to use industrially because of their reduced shelf life, particularly as solutions. Furthermore, such compounds are very sensitive to heat, so that reactions of relatively unreactive aromatics at elevated temperatures result in rapid deactivation of the catalyst with precipitation of palladium black (cf. Fitton et al., J. Organomet. Chem., 1971, 28, 287-291, Dufaud et al., J. Chem. Soc., Chem. Commun, 1990, 426-427).

If a chemically more stable Pd(II) compound such as Pd(OAc)₂ or (PPh₃)₂PdCl₂ is used as catalyst in place of a Pd(0) compound, this more stable compound is converted in a first undefined step, for example, in the reaction with triphenylphosphine, into a Pd(0) species and then takes part in the catalysis cycle as described above (cf. “Comprehensive Organo-metallic Chemistry”, Vol. 8, Pergammon Press, p. 801, 862).

This in-situ preparation of Pd(0) species is the most common approach in industry. However, it has the disadvantage that the catalytically active species appears only after a certain induction time and precise control of a reaction is thus made difficult.

The use of products of the oxidative addition of halogenoaromatics onto palladium(0) species as catalysts for palladium-catalysed cross-couplings has also been described (cf. Heck et al., J. Org. Chem., 1974, 39, 3327-3331). The catalyst is in this case added in solid form.

However, this method of addition is disadvantageous in industry since precise metering and immediate homogeneous distribution of the catalyst in the reaction mixture is made difficult, and those skilled in the art know of the difficulties associated with metering of a solid on an industrial scale, especially against pressure.

Solutions or suspensions of catalytically active palladium compounds do not have these disadvantages but tend to decompose with precipitation of palladium black on standing, even at room temperature.

There is therefore a need for readily meterable solutions or dispersions of palladium catalysts for use in cross-coupling reactions, which solutions or dispersions can be prepared without intermediate isolation. Furthermore, such solutions or dispersions should be thermally stable, should be storage-stable without particular protective measures, and should be able to participate directly in the catalysis cycle.

### SUMMARY OF THE INVENTION

We have now found a process for preparing meterable solutions or dispersions of palladium catalysts of the [Pd(Aryl)L₂X] type, where Aryl represents a substituted or unsubstituted aryl radical, L represents a phosphine ligand or L₂ collectively represents a bisphosphine ligand, and X represents an anion,

comprising reacting

(1) a chloroaromatic, bromoaromatic, iodoaromatic, or arylsulfonate, or an additionally substituted chloroaromatic, bromoaromatic, iodo-aromatic, or arylsulfonate,

(2) a phosphine or diphosphine ligand, and

(3) a palladium salt of the formula

PdY₂ or PdY₂L′₂ or M₂[PdY₄]

where

Y represents a monoanion of an acid, or Y₂ collectively represents a dianion of an acid,

L′ represents an olefin, a nitrile, a phosphine, or L′₂ collectively represents a diolefin, a dinitrile, or a diphosphine, and

M represents an alkali metal ion, ammonium ion, organic ammonium ion, or organic phosphonium ion,

in the presence of a solvent.

### DETAILED DESCRIPTION OF THE INVENTION

The optionally additionally substituted chloroaromatics, bromo-aromatics, or iodoaromatics or arylsulfonates can be, for example, those in which the basic aromatic skeleton has from 6 to 18 skeletal atoms, for example, phenyl, naphthyl, anthracenyl, phenanthryl, or biphenyl skeletons.

Possible further substituents are, for example, hydroxy, chlorine, fluorine, C₁-C₆-alkyl, C₁-C₆-alkoxy, C₁-C₆-fluoroalkyl, C₁-C₆-chloroalkyl, C₁-C₆-fluoroalkoxy, C₁-C₆-chloroalkoxy, tri-C₁-C₆-alkyl-siloxyl, formyl, C₁-C₆-acyl, nitro, cyano, carboxy, NR′₂—, —CO₂-(C₁-C₆-alkyl), —CONR′₂, —OCO-(C₁-C₆-alkyl), —NR′CO(C₁-C₆-alkyl), where each R′ may represent, independently of one another, hydrogen, C₁-C₆-alkyl, or C₆-C₁₀-aryl. In each case, one or more of these further substituents, which may be identical or different, can be present, for example, up to three substituents per aryl radical.

In the process of the invention, preference is given to substituted halogenoaromatics or aryl sulfonates of the formula (I)

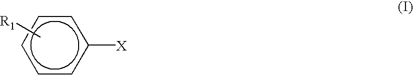

where

R¹ represents hydrogen, methyl, ethyl, n-propyl, isopropyl, n-butyl, isobutyl, tert-butyl, n-pentyl, n-hexyl or cyclohexyl, C₁-C₆-alkoxy, phenacyl, nitro, trifluoromethyl, carboxyl, C₁-C₆-acyl, cyano, —CO₂-(C₁-C₆-alkyl), or —CO₂-phenyl, and, independently thereof,

X represents chlorine, bromine, iodine, trifluoromethanesulfonyl, or p-trifluoromethylphenylsulfonyl.

Particular preference is given to compounds of the formula (I) in which R¹ represents cyano, acetyl or nitro, and, independently thereof, X represents bromine, trifluoromethanesulfonyl, or p-trifluoromethylphenyl-sulfonyl.

Very particular preference is given to 4-acetyl-bromobenzene.

In the process of the invention, preferred ligands L are phosphines of the formula (II)

P(R²)₃ (II)

where

the radicals R² each represent, independently of one another, straight-chain, branched or cyclic C₁-C₆-alkyl or R³-substituted phenyl or R³-substituted naphthyl, where R³ represents hydrogen, straight-chain, branched or cyclic C₁-C₆-alkyl, straight-chain, branched or cyclic C₁-C₆-alkoxy, fluorine, —NH₂, —HN(C₁-C₆-alkyl), —N(C₁-C₆-alkyl)₂, —CO₂-(C₁-C₆-alkyl), —CON(C₁-C₆-alkyl)₂, —OCO-(C₁-C₆-alkyl), —NHCO(C₁-C₆-alkyl), cyano, C₁-C₆-acyl, nitro, hydroxyl, or formyl,

or, as ligands L₂, diphosphines of the formula (III)

(R²)₂P—A—P(R²)₂ (III)

where

R² each have, independently of one another, one of the meanings described for formula (II), and

A represents an unsubstituted or substituted C₁-C₄-alkylene radical, an unsubstituted or substituted 1,2-phenyl radical, an unsubstituted or substituted 1,2-cyclohexyl radical, an unsubstituted or substituted 1,1′- or 1,2-ferrocenyl radical, or a substituted 2,2′-(1,1′-biphenyl) radical.

Particular preference is given to triphenylphosphine, tri(o-tolyl)-phosphine, tri(p-tolyl)phosphine and bis(diphenylphosphino)ethane (DPPE).

Very particular preference is given to triphenylphosphine.

As palladium salts, preference is given to using salts of the formula (IVa)

PdY₂ (IVa)

where

Y represents chloride, bromide, acetate, methanesulfonate, or trifluoromethanesulfonate,

palladium salts of the formula (IVb)

PdY₂L′₂ (IVb)

where

Y is as defined as above, and

L′ each represent acetonitrile, benzonitrile, or benzylnitrile, or

L′₂ collectively represents 1,5-cyclooctadiene, or palladium salts of the formula (IVc)

M₂[PdY₄] (IVc)

where

Y represents chloride or bromide, and

M represents lithium, sodium, potassium, ammonium, or organic ammonium.

Particular preference is given to palladium acetate.

Solvents that can be used for the synthesis of the catalyst are, for example, straight-chain and cyclic aliphatic ethers such as tert-butyl methyl ether, tetrahydrofuran, 1,4-dioxane, and diethyl ether, ketones such as acetone, butyl methyl ketone, and diethyl ketone, and dipolar aprotic solvents such as dimethyl sulfoxide, acetonitrile, dimethylformamide, and N-methylpyrrolidone. Preference is given to using 1,4-dioxane, dimethyl-formamide, acetone, and dimethyl sulfoxide. Particular preference is given to 1,4-dioxane.

In the preparation of the solution or dispersion of the catalyst, it is possible to use, for example, from 0.8 to 1.2 equivalents of an aromatic of the formula (I) per equivalent of the palladium salt of the formula (IVa), (IVb), or (IVc), preferably from 0.9 to 1.1 equivalents and particularly preferably from 0.97 to 1.03 equivalents.

The phosphine ligand can, for example, be used in such amounts that the molar ratio of phosphorus to palladium is from 2:1 to 8:1, preferably from 2:1 to 6:1.

The amount of solvent to be used can, for example, be chosen so that the solution or dispersion of the catalyst contains from 0.001 to 0.2 mol/l (preferably from 0.01 to 0.05 mol/l) of palladium.

The temperature for preparing the solution or dispersion of the catalyst can be, for example, from 50 to 200° C., preferably from 80 to 120° C. The temperature is conveniently from 50° C. up to the boiling point of the solvent.

The pressure in the preparation of the solution or dispersion of the catalyst is not critical and can be, for example, from 0.01 to 10 bar. Preference is given to from 0.1 to 2 bar, particularly preferably from 0.9 to 1.1 bar. The pressures indicated are absolute pressures.

The process of the invention gives solutions or dispersions in an organic solvent of palladium catalysts of the formula (V)

[Pd(Aryl)L₂X] (V)

in which

Aryl represents substituted or unsubstituted phenyl,

X represents the anion of an acid, and

L each represent a phosphine ligand or L₂ collectively represents a bisphosphine ligand.

Preference is given to solutions or dispersions of palladium complexes of the formula (V) in which

Aryl is as defined for formula (I) and, independently thereof,

L is as defined for formula (II) or L₂ is as defined for formula (III), and, independently thereof,

X represents chloride, bromide, iodide, acetate, trifluoromethane-sulfonyl, or p-trifluoromethanephenylsulfonyl.

Very particular preference is given to a solution of bis(triphenyl-phosphino) -(4-acetylphenyl)-palladium(II) bromide in dioxane.

Solutions or dispersions prepared according to the invention can be stored without problems for a number of days without prior isolation and can be added directly to a cross-coupling reaction.

Surprisingly, the solutions or dispersions of the catalysts have been found to be particularly stable. Even after storage for a number of weeks in air, the catalytic activity did not decrease. Precipitation of elemental palladium, e.g., as palladium black, was also not observed.

The novel solutions or dispersions of palladium catalysts can be used, for example, in reactions such as Suzuki coupling, alkyne coupling, various carbonylations, and Heck reactions.

For example, the novel solutions or dispersions of palladium catalysts can advantageously be used in a process for preparing aromatic alkynes of the formula (VIII)

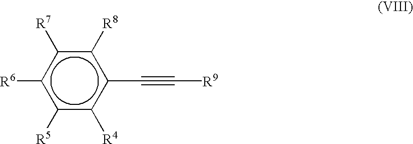

where

R⁴ to R⁸ can each be, independently of one another, hydrogen, C₁-C₈-alkyl, (C₁-C₈)-alkoxy, O-phenyl, phenyl, fluorine, chlorine, —OH, —CN, —COOH, —NH₂, —NH(C₁-C₁₂)alkyl, —N(C₁-C₁₂)-alkyl₂, C-Hal₃, —NHCO-(C₁-C₈)-alkyl, CO-(C₁-C₈)-alkyl, COO-(C₁-C₁₂)-alkyl, CONH₂, CO-(C₁-C₁₂)-alkyl, NHCOH, NCOO-(C₁-C₈)-alkyl, CO-phenyl, COO-phenyl, (C₁₋₄)-CO₂-(C₁₋₈)-alkyl, (C₁₋₄)-CO₂H, PO-phenyl₂, PO-(C₁-C₈)-alkyl₂, or a 5-membered heteroaryl or 6-membered heteroaryl in which the heteroatom is selected from the group consisting of nitrogen, sulfur, and oxygen, and

R⁹ can represent, independently thereof, hydrogen, C₁-C₈-alkyl, (C₁-C₈)-alkoxy or phenyl,

by reacting halogenoaromatics or aryl halides of the formula (VI)

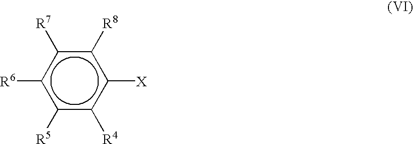

where

R⁴ to R⁸ are as defined above, and

X represents chlorine, bromine, iodine, trifluoromethane-sulfonyl, p-trifluoromethylphenylsulfonyl, methanesulfonyl, or p-toluenesulfonyl,

with acetylenes of the formula (VII)

HC≡CR⁹ (VII)

where R⁹ is as defined above.

Furthermore, the novel solutions or dispersions of palladium catalysts can, for example, advantageously be used in a process for preparing aromatic olefins of the formula (X)

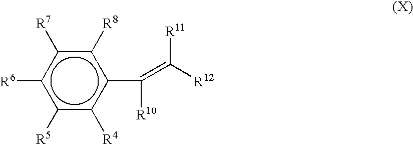

where

R⁴ to R⁸ are as defined above,

R¹⁰, independently thereof, can represent hydrogen, C₁-C₈-alkyl, (C₁-C₈)-alkoxy, phenyl, fluorine, and

R¹¹ and R¹² can each represent, independently thereof, hydrogen, C₁-C₈-alkyl, (C₁-C₈)-alkoxy, O-phenyl, phenyl, fluorine, chlorine, —CN, —COOH, —CHO, —NH₂, —NH(C₁-C₁₂)-alkyl, —N(C₁-C₁₂)-alkyl₂, C-Hal₃, —NHCO-(C₁-C₈)-alkyl, CO-(C₁-C₈)-alkyl, COO-(C₁-C₁₂)-alkyl, CONH₂, CO-(C₁-C₁₂)-alkyl, NHCOH, NCOO-(C₁-C₈)-alkyl, CO-phenyl, COO-phenyl, (C₁₋₄)-CO₂-(C₁₋₈)-alkyl, (C₁₋₄)-CO₂H, PO-phenyl₂, PO-(C₁-C₈)-alkyl₂, or a 5-membered heteroaryl or 6-membered heteroaryl in which the heteroatom is selected from the group consisting of nitrogen, sulfur, and oxygen,

by reacting halogenoaromatics of the formula (VI) in which R⁴ to R⁸ and X are as defined above with olefins of the formula (IX)

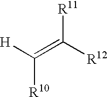

where R¹⁰, R¹¹, and R¹² are as defined above,

in the presence of the solutions or dispersions of palladium catalysts according to the invention.

Furthermore, the novel solutions or dispersions of palladium catalysts can, for example, advantageously be used in a process for preparing bisaryl compounds of the formula (XII)

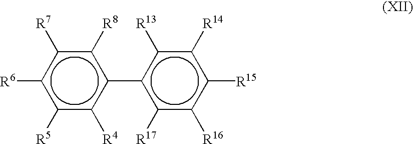

where

R⁴ to R⁸ are as defined above, and

R¹³ to R¹⁶ can, independently of one another and of R⁴ to R⁸, have the meanings specified above for R⁴ to R⁸,

by reacting halogenoaromatics of the formula (VI) in which R⁴ to R⁸ and X are as defined above with arylboron derivatives of the formula (XI)

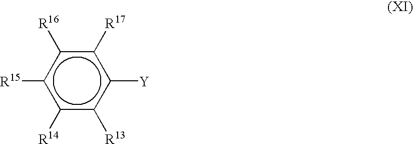

where

R¹³ to R¹⁶ can each, independently of one another, have one of the meanings given above for R⁴ to R⁸ and

Y represents B(OH)₂or B(O-(C₁-C₆)-alkyl)₂,

in the presence of the solutions or dispersions of palladium catalysts according to the invention.

Furthermore, the novel solutions or dispersions of palladium catalysts can, for example, advantageously be used in a process for preparing aromatic carboxylic acid derivatives of the formula (XIV)

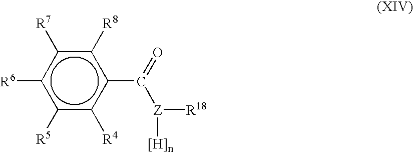

where

R⁴ to R⁸ are as defined above,

Z, independently thereof, represents oxygen or nitrogen,

n is 0 when Z is oxygen and n is 1 when Z is nitrogen, and

R¹⁸ can, independently thereof, represent hydrogen, branched or unbranched linear or cyclic C₁-C₈-alkyl, or substituted phenyl,

by reacting halogenoaromatics of the formula (VI), in which R⁴ to R⁸ and X are as defined above,

with carbon monoxide and

with compounds of the formula (XIII)

[H]ₙ—Z—R¹⁸

where

Z and R¹⁸ are as defined above, and

n is 1 when Z is oxygen and n is 2 when Z is nitrogen,

in the presence of the solutions or dispersions of palladium catalysts according to the invention.

Furthermore, the novel solutions or dispersions of the palladium catalysts can, for example, advantageously be used in a process for preparing aromatic aldehydes of the formula (XV)

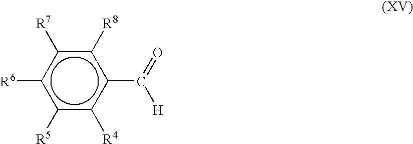

where R⁴ to R⁸ are as defined above,

by reacting halogenoaromatics of the formula (VI), in which R⁴ to R⁸ and X are as defined above,

with carbon monoxide and hydrogen,

in the presence of the solutions or dispersions of palladium catalysts according to the invention.

Solvents that can be used for the preparation according to the invention of substituted aromatics are, for example, aromatic solvents such as alkylbenzenes, dialkylbenzenes, and trialkylbenzenes, ethers such as diethyl ether, methyl tert-butyl ether, tetrahydrofuran, and dioxane, ketones such as acetone and butyl methyl ketone, esters of aliphatic carboxylic acids such as ethyl acetate and butyl acetate, dimethyl sulfoxide, N,N-dialkylamides of aliphatic carboxylic acids such as dimethylformamide and dimethylacetamide, or alkylated lactams such as N-methyl caprolactam and N-methylpyrrolidone, trialkylamines such as triethylamine, and alcohols such as methanol, ethanol, isopropanol, n-butanol, tert-butanol, isobutanol, pentanols, and hexanols or mixtures thereof.

In the preparation according to the invention of substituted aromatics, a total of, for example, from 0.001 to 5 mol % (preferably from 0.01 to 2 mol %, particularly preferably from 0.1 to 1 mol %) of the solutions or suspensions of palladium catalysts according to the invention can be added to the reaction mixtures.

It is possible, for example, for from 0 to 80% of the catalyst solution to be placed in the reaction solution initially and the balance to 100% being added during the reaction.

The time over which the catalyst solution or suspension is metered in can be matched to the reaction rate and range from a few minutes to more than 12 hours.

The acid HX formed in the reaction can be neutralized by addition of a base, particularly an amine or an alkali metal salt or alkaline earth metal salt of a weak acid. Preference is given to using tri-n-butylamine and sodium acetate or sodium carbonate.

The number of equivalents of base used is not critical within a wide range and can be, for example, from 0.5 to 3 equivalents, preferably from 0.9 to 1.1 equivalents.

Furthermore, it is possible for, for example, from 0.1 to 10 equivalents of the phosphines of the formula (II) and/or (III) to be additionally added to the reaction mixture.

In addition, salts of halides and pseudohalides of the alkali metals, alkaline earth metals, and metals of transition groups 6 to 8 can be added to the reaction solution.

It is likewise possible, for example, to add trialkylammonium, trialkylphosphonium, trialkylarsonium, tetraalkylammonium, tetraalkyl-phosphonium, or tetraalkylarsonium salts to the reaction solution.

The reaction temperatures can be, for example, in the range from 20 to 200° C., preferably in the range from 60 to 180° C. and particularly preferably in the range from 90 to 150° C.

The reaction can be carried out at pressures in the range from 1 bar to 100 bar, preferably from 1 to 16 bar.

In carbonylations, the CO pressure can be, for example, from 0.1 to 100 bar, preferably from 1 bar to 20 bar, particularly preferably from 3 to 12 bar.

In the preparation of aromatic aldehydes, the hydrogen pressure can be, for example, from 0.1 to 100 bar, preferably from 1 bar to 20 bar.

After the reaction is complete, the palladium of the catalyst can be recovered as palladium salts and palladium black, for example, by filtration. This filtration can be carried out, for example, using an activated carbon filter.

A particular advantage of the invention is that the reactions can be carried out at elevated temperatures, because the increasing deactivation of the catalyst at higher temperatures can be compensated by metered addition of further catalyst.

The following examples serve only to illustrate the invention and do not imply a limitation of the scope of the invention either in respect of the apparatus employed or the substrates selected. Those skilled in the art will readily understand that known variations of the conditions of the following procedures can be used. unless otherwise noted, all temperatures are degrees Celsius and all percentages are percentages by weight.

### EXAMPLES

### Example 1

800 g of 1,4-dioxane were placed in a 1 liter reservoir provided with jacket heating and made inert at room temperature by 5 cycles of alternate evacuation to 100 mbar and subsequent breaking of the vacuum with nitrogen. While blanketing with nitrogen, 3.2 g of palladium(II) acetate, 18.9 g of triphenylphosphine, and 2.9 g of 4-bromo-acetophenone were subsequently added. The mixture was refluxed for 1 hour and subsequently stirred for another 1 hour at reflux temperature. The solution prepared in this way could be used directly as catalyst.

### Example 2

### Carbonylation

1443.1 g of 4-bromo-butyryl-o-toluidine, 37.8 g of triphenyl-phosphine, 1248.0 g of tri-n-butylamine, and 5060.0 g of methanol were placed in a 16 liter Pfaudler enamelled steel reactor. The reaction mixture was made inert by 3 cycles of evacuation to 100 mbar and subsequent breaking of the vacuum with nitrogen, while stirring. The reactor was subsequently evacuated again and pressurized to 2 bar with about 28 g of carbon monoxide. The reaction solution was heated to 115° C. and the pressure was subsequently brought to 8 bar by injection of further CO. 825 g of the catalyst solution prepared in Example 1 were pumped in over a period of 8 hours. After all of the catalyst had been metered in, the mixture was stirred until no more CO was absorbed. If insufficient CO had been absorbed, further catalyst solution could be metered in. The mixture was depressurized, flushed with nitrogen, and cooled to 50° C. This resulted in precipitation of a yellow solid. The suspension was filtered through an activated carbon filter preceded by a paper filter. The reaction solution obtained contained, according to HPLC analysis, 1177.1 g (89.3%) of methyl (N-butyryl)-4-amino-3-methylbenzoate.

### Example 3

### Heck Reaction

11.01 g of methyl p-bromobenzoate, 6.09 g of methyl acrylate, and 4.52 g of sodium acetate were added to 50 g of N,N-dimethylacetamide. The apparatus was flushed with nitrogen and made inert. At 130° C., 13.4 g of the catalyst solution from Example 1 were added to the solution and the mixture was stirred for 14 hours. A sample was subsequently taken. According to quantitative GC analysis, the sample contained 7.91 g (72%) of methyl p-carboxymethylcinnamate.

### Example 4

Suzuki Coupling

5.08 g of p-bromoacetophenone, 3.45 g of benzeneboronic acid, and 6.91 g of potassium carbonate were placed in 40 ml of xylene and made inert with nitrogen. 3.38 g of catalyst solution from Example 1 were subsequently metered in at 120° C. The mixture was allowed to react at 120° C. for a total of 9 hours, allowed to cool, and washed with water. A sample contained, according to quantitative GC analysis, 4.76 g (97%) of 4-acetoxybiphenyl.

### Example 5

### Alkyne Coupling

8.12 g of p-bromoacetophenone and 5.0 g of phenylacetylene were dissolved in 120 ml of triethylamine and made inert with nitrogen. At 90° C., 0.03 g of copper(I) bromide were added and 5.41 g of the catalyst solution from Example 1 were metered in. The mixture was stirred at 90° C. for 6 hours and another 60 ml of triethylamine and 5.4 g of the catalyst solution were subsequently added. After a further reaction time of 3 hours, the mixture was cooled and the solid was filtered off. The organic phase was evaporated on a rotary evaporator and taken up in dichloromethane. Quantitative GC analysis indicated that 8.37 g (95%) of 4-acetoxytolane were present.

What is claimed is:

1. A process for preparing a meterable solution or dispersion of a palladium catalyst of the formula
[Pd(Aryl)L₂X]
where
Aryl represents a substituted or unsubstituted aryl radical,
L represents a phosphine ligand, or L₂ collectively represents a bisphosphine ligand, and
X represents an anion,
comprising reacting
(1) a substituted or nonsubstituted chloroaromatic, bromoaromatic, iodoaromatic, or arylsulfonate,
(2) a phosphine or diphosphine ligand, and
(3) a palladium salt of the formula
PdY₂ or PdY₂L′₂ or M₂[PdY₄]
where
Y represents an anion of an acid, or Y₂ collectively represents a dianion of an acid,
L′ represents an olefin, a nitrile, a phosphine, or L′₂ collectively represents a diolefin, a dinitrile, or a diphosphine, and
M represents an alkali metal ion, ammonium ion, organic ammonium ion or organic phosphonium ion,
in the presence of a solvent.

2. A process according to claim 1 wherein the chloroaromatic, bromoaromatic, iodoaromatic, or arylsulfonate is an additionally substituted compound of the formula (I) 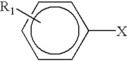
where
R represents methyl, ethyl, n-propyl, isopropyl, n-butyl, isobutyl, tert-butyl, n-pentyl, n-hexyl or cyclohexyl, C₁-C₆-alkoxy, phenacyl, nitro, trifluoromethyl, carboxyl, C₁-C₆-acyl, —CO₂-(C₁-C₆-alkyl), or —CO₂-phenyl and, independently thereof, and
X represents chlorine, bromine, iodine, trifluoromethane-sulfonyl, methanesulfonyl, p-trifluoromethylphenylsulfonyl, or p-toluenesulfonyl.

3. A process according to claim 1 wherein the ligand is a phosphine of the formula P(R²)₃, where
R² each represent, independently of one another, straight-chain, branched or cyclic C₁-C₆-alkyl or R³-substituted phenyl or R³-substituted naphthyl, where
R³ represents straight-chain, branched or cyclic C₁-C₆-alkoxy, fluorine, NH₂, —HN(C₁-C₆-alkyl), —N(C₁-C₆-alkyl)₂, —CO₂-(C₁-C₆-alkyl), —CON(C₁-C₆-alkyl), —OCO-(C₁-C₆-alkyl), —NCO(C₁-C₆-alkyl), cyano, C₁-C₆-acyl, nitro, hydroxyl, or formyl, or
a bisphosphine of the formula (R²)₂P—A—P(R²)₂, where
R² each represent, independently of one another, straight-chain, branched or cyclic C₁-C₆-alkyl or R³-substituted phenyl or R³-substituted naphthyl, where
R³ represents straight-chain, branched or cyclic C₁-C₆-alkoxy, fluorine, NH₂, —HN(C₁-C₆-alkyl), —N(C₁-C₆-alkyl)₂, —CO₂-(C₁-C₆-alkyl), —CON(C₁-C₆-alkyl), —OCO-(C₁-C₆-alkyl), —NCO(C₁-C₆-alkyl), cyano, C₁-C₆-acyl, nitro, hydroxyl, or formyl, and
A represents an unsubstituted or substituted C₁-C₄-alkylene radical, an unsubstituted or substituted 1,2-phenyl radical, an unsubstituted or substituted 1,2-cyclohexyl radical, an unsubstituted or substituted 1,1- or 1,2-ferrocenyl radical, or a substituted 2,2′-(1,1′-biphenyl) radical.

4. A process according to claim 1 wherein the palladium salt is a palladium salt PdY₂, where
Y represents chloride, bromide, acetate, methanesulfonate, or trifluoromethanesulfonate,
a palladium salt PdY₂L′₂, where
Y represents chloride, bromide, acetate, methanesulfonate, or trifluoromethanesulfonate, and
L′ represents acetonitrile, benzonitrile, or benzyl nitrile, or L′₂ collectively represents 1,5-cyclooctadiene, or
a palladium salt M₂[PdY₄], where
M represents lithium, sodium, potassium, or ammonium, and
Y represents chloride or bromide.

5. A process according to claim 1 wherein the solvent is N,N-dimethylformamide, acetone, dimethyl sulfoxide, or 1,4-dioxane.

6. A process according to claim 1 wherein the solvent is 1,4-dioxane.

7. A process according to claim 1 carried out at a temperature of from 50° C. to 200° C.

8. A process according to claim 1 additionally comprising further diluting the reaction solution by addition of solvent after the reaction.

9. A solution or dispersion of a palladium catalyst of the formula (V),
[Pd(Aryl)L₂X] (V),
where
Aryl represents an unsubstituted or substituted aryl radical,
L represents a phosphine ligand or L₂ together represents a bisphosphine ligand,
X represents chloride, bromide, iodide or a sulfonate.

10. A solution or dispersion of a palladium catalyst according to claim 9 where Aryl represents a phenyl group substituted by cyano, straight-chain or branched C₁-C₄-acyl, phenacyl, nitro, trifluoromethyl, carboxyl, straight-chain or branched C₁-C₆-alkylcarboxyl, or phenyl-carboxyl.

11. A solution or dispersion of a palladium catalyst according to claim 9 where
L represents a phosphine P(R²)₃, where
R² each represent, independently of one another, straight-chain, branched or cyclic C₁-C₆-alkyl or R³-substituted phenyl or R³-substituted naphthyl, where
R³ represents straight-chain, branched or cyclic C₁-C₆-alkoxy, fluorine, NH₂, HN(C₁-C₆-alkyl), N(C₁-C₆-alkyl)₂, CO₂-(C₁-C₆-alkyl), CON(C₁-C₆-alkyl), OCO-(C₁-C₆-alkyl), NCO(C₁-C₆-alkyl), cyano, C₁-C₆-acyl, nitro, hydroxyl, or formyl, or
L₂ collectively represents a bisphosphine of the formula (R²)₂P—A—P(R²)₂, where
R² each represent, independently of one another, straight-chain, branched or cyclic C₁-C₆-alkyl or R³-substituted phenyl or R³-substituted naphthyl, where
R³ represents straight-chain, branched or cyclic C₁-C₆-alkoxy, fluorine, NH₂, HN(C₁-C₆-alkyl), N(C₁-C₆-alkyl)₂, CO₂-(C₁-C₆-alkyl), CON(C₁-C₆-alkyl), OCO-(C₁-C₆-alkyl), NCO(C₁-C₆-alkyl), cyano, C₁-C₆-acyl, nitro, hydroxyl, or formyl, and
A represents an unsubstituted or substituted C₁-C₄-alkylene radical, an unsubstituted or substituted 1,2-phenyl radical, an unsubstituted or substituted 1,2-cyclohexyl radical, an unsubstituted or substituted 1,1′- or 1,2-ferrocenyl radical, or a substituted 2,2′-(1,1′-binaphthyl) radical.

12. A solution or dispersion of a palladium catalyst according to claim 9 where X represents chloride, bromide, iodide, methanesulfonate, trifluoromethylsulfonate, p-nitrophenylsulfonate, p-trifluoromethylphenyl-sulfonate, or p-toluenesulfonate.

13. A catalyst composition comprising a solution or dispersion as claimed in claim 9.

14. A process for preparing a substituted aromatic comprising carrying out a cross-coupling reaction in the presence of a solution or dispersion of a palladium catalyst according to claim 9.

15. A process for preparing an aryl alkyne comprising reacting a substituted or unsubstituted halogenoaromatic or aryl sulfonate with an alkyne in the presence of a solution or dispersion of a palladium catalyst according to claim 9.

16. A process for preparing a bisaryl comprising reacting a substituted or unsubstituted halogenoaromatic or aryl sulfonate with an aryl-boric acid derivative in the presence of a solution or dispersion of a palladium catalyst according to claim 9.

17. A process for preparing an arylalkene comprising reacting a substituted or unsubstituted halogenoaromatic or aryl sulfonate with an alkene in the presence of a solution or dispersion of a palladium catalyst according to claim 9.

18. A process for preparing an aromatic aldehyde comprising reacting a substituted or unsubstituted halogenoaromatic or aryl sulfonate with carbon monoxide and hydrogen in the presence of a solution or dispersion of a palladium catalyst according to claim 9.

19. A process for preparing an arylcarboxylic acid derivative comprising reacting a substituted or unsubstituted halogenoaromatic or arylsulfonate with carbon monoxide and an alcohol or primary amine in the presence of a solution or dispersion of a palladium catalyst according to claim 9.

20. A process according to claim 14 wherein the reaction temperature is from 20 to 200° C.

21. A process according to claim 14 wherein the reaction temperature is from 60 to 180° C.

22. A process according to claim 14 wherein a base is added to the reaction.

23. A process according to claim 14 wherein the palladium or palladium compound present in the reaction is recovered after the reaction by filtration.
